(19) United States
(12) Patent Application Publication
(10) Pub. No.: US 2016/0111062 A1
(43) Pub. Date: Apr. 21, 2016

(54) AMBIENT LIGHT-BASED IMAGE ADJUSTMENT

(71) Applicant: INTEL CORPORATION, Santa Clara, CA (US)

(72) Inventor: Richmond Hicks, Aloha, OR (US)

(73) Assignee: INTEL CORPORATION, Santa Clara, CA (US)

(21) Appl. No.: 14/515,165

(22) Filed: Oct. 15, 2014

(51) Int. Cl. G09G 5/02; G06T 7/40

(52) U.S. Cl. CPC G09G 5/02; G06T 7/408; G09G 2360/144

(57) ABSTRACT

Techniques for image rendering are described herein. The techniques may include receiving image data comprising a captured image and ambient light data indicating a level and color of ambient light present during capture of the image. The techniques may also include detecting ambient light of an environment in which the captured image is to be displayed, and adjusting spectral content of the captured image based on the detected ambient light and the ambient light present during capture of the captured image.

### TECHNICAL FIELD

This disclosure relates generally to image adjustment. More specifically, the disclosure describes image adjustment based on ambient light.

### BACKGROUND

Computing devices increasingly are being used to view images on a display device of the computing device. However, differences in ambient light during image capture when compared to ambient light when being viewed may result in a maladaptation of the viewed image. A maladaptation may be a visual misperception of an eye resulting in an observer perceiving colors differently in various ambient lighting environments. For example, a color of an object during image capture may be perceived as red to an observer present during the image capture with a given ambient lighting. However, once the image is captured and retransmitted via a display, such as a computer monitor, the object may appear to have a slightly different color due to the viewer's eye adaptation to the ambient lighting of an environment in which the captured image is displayed.

### BRIEF DESCRIPTION OF DRAWINGS

FIG. 1 is a block diagram of a computing device having rendering application to render images at the computing device;

FIG. 2 is process flow diagram illustrating image rendering performed at the computing device;

FIG. 3 is a diagram illustrating a calibration process at a computing device;

FIG. 4 is a diagram illustrating a calibration of an external display device;

FIG. 5 is a block diagram illustrating a method of image rendering based on ambient light data; and

FIG. 6 is a block diagram depicting an example of a computer-readable medium configured to render images based on ambient light data.

### DETAILED DESCRIPTION

The subject matter disclosed herein relates to techniques for image rendering based on ambient light data. As discussed above, a user may misinterpret the color of an object based on the user's adaptation to the ambient lighting rather than to the display. The techniques described herein detect ambient lighting data of the environment within which the image is displayed, and adjust the rendered image based on a difference between the ambient light detected and the color recorded during the original image capture.

For example, an image may be captured of an object having a given color, such as a red sweater. The ambient light existing within an image capture environment at which the red sweater image is captured may be determined and stored. When the image containing the red sweater is viewed at a display, such as a monitor of a computing device, the color of the sweater may appear lighter than red, or darker than red, to an observer due to the user's adaptation to the ambient lighting occurring within the display environment. The techniques described herein include adjusting spectral content of the rendered image based on the ambient lighting of the display environment and a known impact on user perception. For example if the ambient lighting is strongly blue in color, blue can be added to the image of the red sweater to display it as it would look in the local ambient illumination and therefore matching what the user would see if the sweater was present—as well as matching the user's eye adaptation.

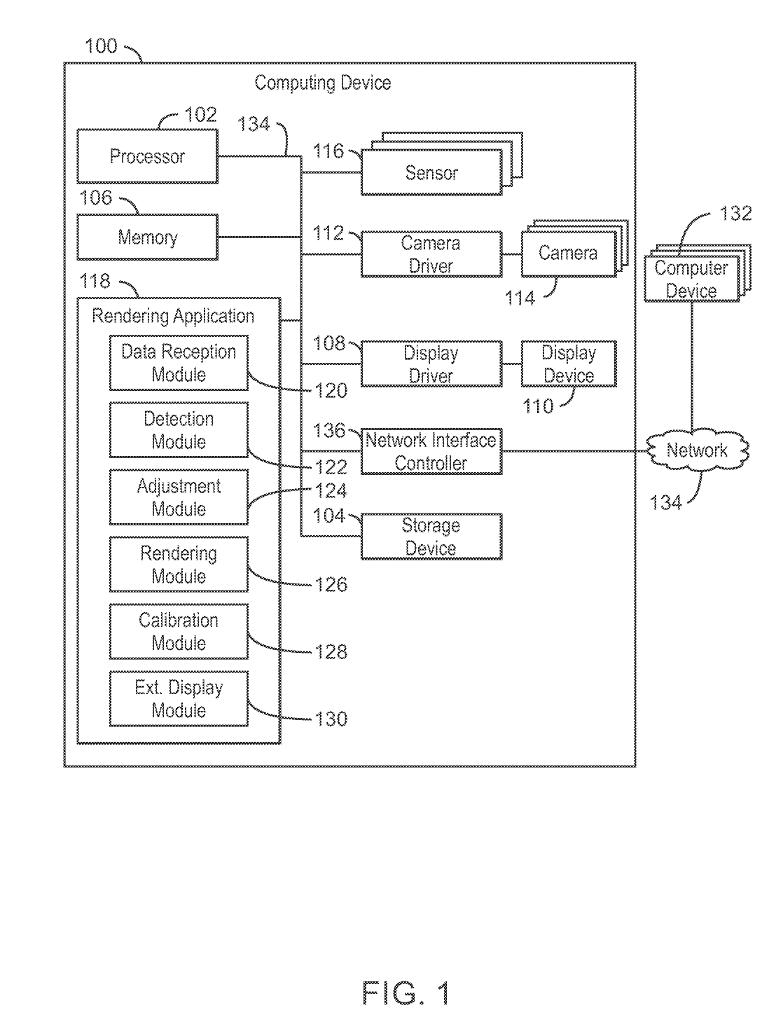

FIG. 1 is a block diagram of a computing device having rendering application to render images at the computing device. The computing device 100 may include a processor 102, a storage device 104 including a non-transitory computer-readable medium, and a memory device 106. The computing device 100 may include a display driver 108 configured to operate a display device 110 to render images at a graphical user interface (GUI), a camera driver 112 configured to operate one or more camera devices 114. In some aspects, the computing device 100 includes one or more sensors 116 configured to capture ambient light data.

The computing device 100 includes modules of a rendering application 118 configured to adjust spectral content of images displayed at the display device 110. As illustrated in FIG. 1, the modules include a data reception module 120, a detection module 122, an adjustment module 124, a rendering module 126, a calibration module 128, and an external display module 130. The modules 120, 122, 124, 126, 128, and 130 may be logic, at least partially comprising hardware logic. In some examples, the modules 120, 122, 124, 126, 128, and 130 may be instructions stored on a storage medium configured to be carried out by a processing device, such as the processor 102. In yet other examples, the modules 120, 122, 124, 126, 128, and 130 may be a combination of hardware, software, and firmware. The modules 120, 122, 124, 126, 128, and 130 may be configured to operate independently, in parallel, distributed, or as a part of a broader process. The modules 120, 122, 124, 126, 128, and 130 may be considered separate modules or sub-modules of a parent module. Additional modules may also be included. In any case, the modules 120, 122, 124, 126, 128, and 130 are configured to carry out operations.

The data reception module 120 is configured to receive image data comprising a captured image an ambient light data indicating a level and color of ambient light present during capture of the captured image. In some cases, the captured image may be captured remotely at one or more remote computing devices 132 provided to the computing device 100 via a network 134 communicatively coupled to a network interface controller 136 of the computing device 100. For example, the image data may include a captured image of an item, such as an item for sale on a website. The image data may also include ambient light data indicating the level and color of ambient occurring during the image capture of the image.

The detection module 122 is configured to detect the ambient light of an environment in which the captured image is to be displayed. In some cases, the detection module 122 may be configured to gather ambient light data via one or more of the sensors 116, or via one or more of the camera devices 114. The ambient light of the environment in which the captured image is to be displayed may be used to adjust the captured image. The adjustment module 124 may adjust spectral content of the captured image based on the detected ambient light and the ambient light present, or white balance information recorded during capture of the image. In other words, the adjustment module 124 may adjust the spectral content of the captured image based on the light level and color occurring in the environment within which the image was captured in comparison to the light level and color occurring in the environment within which the image is to be displayed via the display device 110. Adjusting spectral content may include altering one or more colors of the captured image such that the image may appear to have a consistent coloring between image capture environment and the display environment. The adjustment performed may correct a maladaptation of human perception resulting from a mismatch in the color temperature of the display and the ambient illumination present around the display device 110.

In some cases, the detection module 122 may be further configured to identify a color of an object within the environment in which the image is to be displayed. The detection module 122 may be configured to dynamically monitor the identified color and determine changes in the color of the object indicating changes in the ambient light. Changes may be reported to the adjustment module 124 to provide dynamic updates in the adjustment of the spectral content of the displayed image.

As discussed above, in embodiments, the computing device 100 may receive image data from remote computing devices 132, such as internet servers, via the network interface controller 136 communicatively coupled to the network 134. In some scenarios, the network interface controller 136 is an expansion card configured to be communicatively coupled to a system bus 134. In other scenarios, the network interface controller 136 may be integrated with a motherboard of a computing device, such as the computing device 100. In embodiments, the rendering application 118 may be carried out, and/or stored on, a remote computing device, such as one of the remote computing devices 132. For example, ambient light data of the display environment may be sent to the remote computing devices 132 and the captured image may be adjusted remotely before providing the image data to the computing device 100.

The rendering application 118 may also include a rendering module 126. The rendering module 126 is configured to render the adjusted captured image at the display device 110 via the display driver 108. In some cases, the rendering module 126 may be executed by, or work in conjunction with, a graphics processing unit (not shown) to render the adjusted captured image at the display device 110.

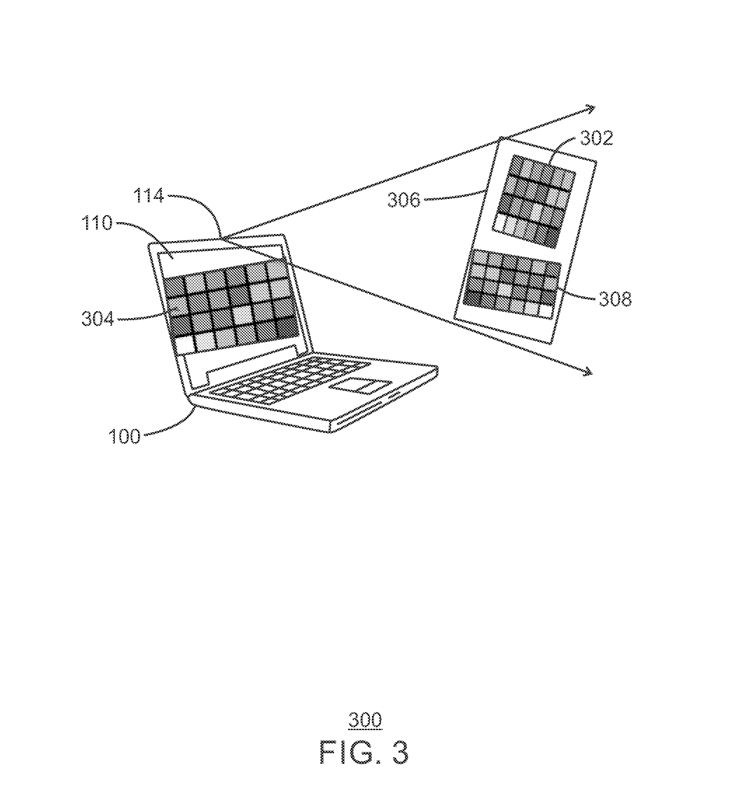

The calibration module 128 may be configured to calibrate the one or more cameras 114 and external display module 130. For example, the calibration module 128 may be configured to capture a first image of a first color pattern, capture a second image of a reflection of a second color pattern being rendered at the display device 110, and apply correction coefficients to color channels to reduce a difference between the first image and the second image, as discussed in more detail below in regard to FIG. 3.

In some embodiments, the external display module 130 may be configured to calibrate an external display (not shown). For example, the computing device 100 may be configured to provide an image data feed to the external display, such as a television. However, the external display may not enable calibration in the same way as the computing device 100. In some cases, an image including a color red may be rendered by the external display as pink. In this scenario, the external display module 130 is configured to receive image data comprising a rendering of the captured image at the external display via one or more of the cameras 114. The external display module 130 is also configured to determine a color difference between the rendering of the captured image at the external display and a reference model of the captured image. The reference model may be based on image data received and calibration of the one or more cameras 114 performed by the calibration module 128. For example, a reference model may indicate that a given area of a captured image is red, yet the image data received via the one or more cameras 114 aimed at the external display may indicate that the external display is rendering the area as pink. Therefore, the external display module 130 may be configured to adjust a data feed to the external display based on the difference between the rendered image at the external display and the reference model.

The computing device 100, as referred to herein, may be a mobile computing device wherein components such as a processing device, a storage device, and a display device are disposed within a single housing. For example, the computing device 100 may be a tablet computer, a smartphone, a handheld videogame system, a cellular phone, an all-in-one slate computing device, or any other computing device having all-in-one functionality wherein the housing of the computing device houses the display was well as components such as storage components and processing components.

The processor 102 may be a main processor that is adapted to execute the stored instructions. The processor 102 may be a single core processor, a multi-core processor, a computing cluster, or any number of other configurations. The processor 102 may be implemented as Complex Instruction Set Computer (CISC) or Reduced Instruction Set Computer (RISC) processors, x86 Instruction set compatible processors, multi-core, or any other microprocessor or central processing unit (CPU).

The memory device 106 can include random access memory (RAM) (e.g., static random access memory (SRAM), dynamic random access memory (DRAM), zero capacitor RAM, Silicon-Oxide-Nitride-Oxide-Silicon SONOS, embedded DRAM, extended data out RAM, double data rate (DDR) RAM, resistive random access memory (RRAM), parameter random access memory (PRAM), etc.), read only memory (ROM) (e.g., Mask ROM, programmable read only memory (PROM), erasable programmable read only memory (EPROM), electrically erasable programmable read only memory (EEPROM), etc.), flash memory, or any other suitable memory systems. The main processor 102 may be connected through the system bus 134 (e.g., Peripheral Component Interconnect (PCI), Industry Standard Architecture (ISA), PCI-Express, HyperTransport®, NuBus, etc.) to components including the memory 106 and the storage device 104.

The block diagram of FIG. 1 is not intended to indicate that the computing device 100 is to include all of the components shown in FIG. 1. Further, the computing device 100 may include any number of additional components not shown in FIG. 1, depending on the details of the specific implementation.

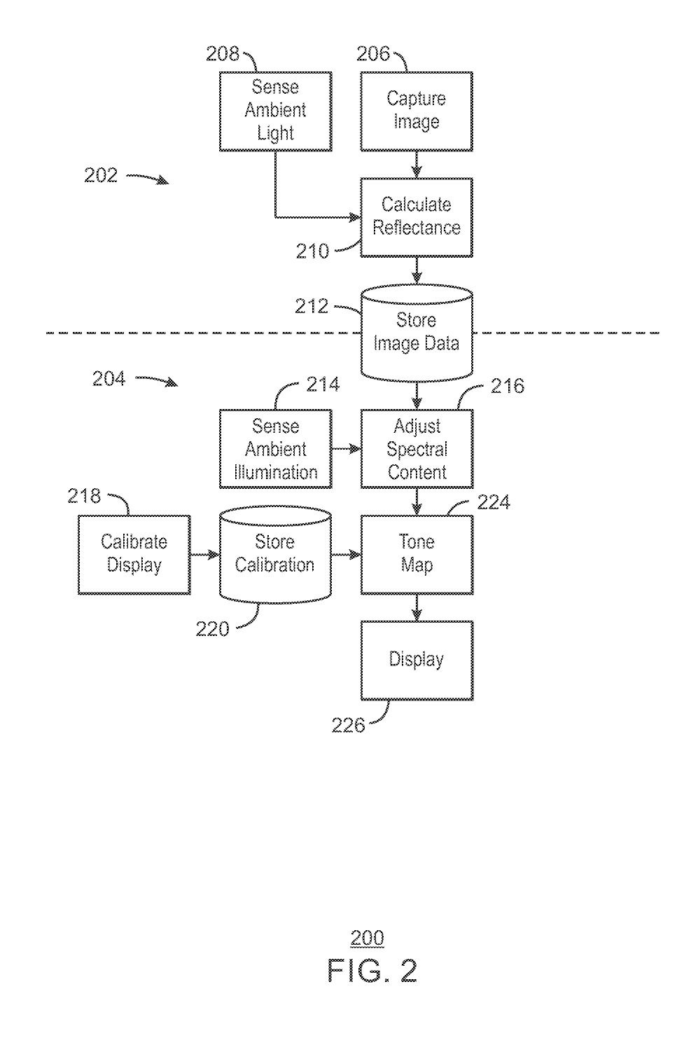

FIG. 2 is process flow diagram illustrating image rendering performed at the computing device. The process flow diagram 200 is divided into an image capture phase 202 wherein an ambient lighting level exists within an image capture environment, and an image display phase 204 wherein an ambient lighting level exists within an image display environment. At block 206, an image is captured of a given scene or object. At block 208, ambient lighting is sensed. Ambient light may be sensed via one or more sensors at an image capture device. In some cases, reflectance is calculated at 210. Once ambient light is known, reflectance may be calculated based on the light detected at the image capture device in the image capture environment.

At 212, image data is stored including the ambient light data or white balance information and the image captured. In embodiments, the image data may be stored in a format having metadata fields for storing the ambient light or white balance data. In one case, the ambient light or white balance data may be stored in an exchangeable image file (EXIF) format field. For example, a Joint Photographic Experts Group (JPEG) file may be used wherein ambient light or white balance data is stored in an EXIF field of the JPEG. Moving to the display phase 204, at 214 the ambient light in the display environment is sensed, and at block 216, spectral content of the image captured at 206 may be adjusted based on the sensed ambient light at 214 in view of the sensed ambient light or white balance data 208. For example, if the ambient lighting in the capture phase 202 is warmer than the ambient lighting in the display phase 204, one or more wavelengths of the captured image may be lowered such that a user may perceive a more accurate color representation of the captured image in the display phase 204.

Further steps may include calibration of the display at 218, storing the calibration at 220, and creating a tone map at 224. Based on the display calibration and the adjustment of spectral content at 216, tone mapping may optimized for accuracy and expected eye adaptation of the user over contrast. At 226, the adjusted image is displayed at a display device, such as the display device 110 of FIG. 1.

FIG. 3 is a diagram illustrating a calibration process at a computing device. As discussed above, the display device 110 of the computing device may be calibrated. The techniques described herein include calibration of the display device 110 via capturing an image of a color target 302 via a camera, such as one or more of the camera devices 114 in FIG. 1. The color target 302 may be compared with a color chart 304 rendered at the display device 110 and reflected back to the camera 114 via a reflective surface 306 such as a mirror, as indicated at 308.

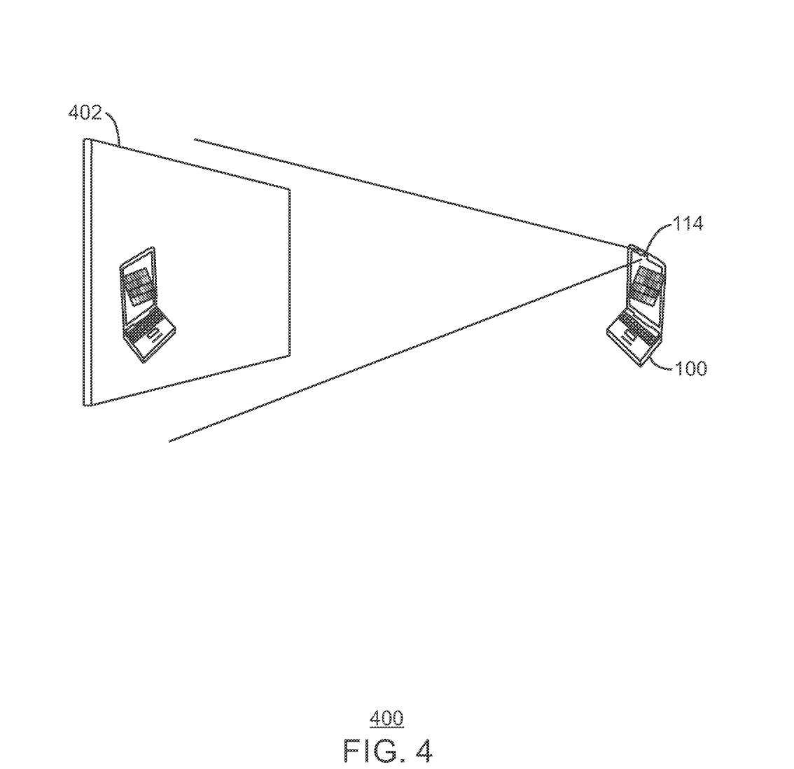

FIG. 4 is a diagram illustrating a calibration of an external display device. As discussed above in regard to FIG. 1, in some aspects, an external display 402 may be used to render captured images. In this scenario, the computing device 100 may provide a data feed to the external display device 402. However, the external display device 402 may not be configurable in terms of calibration by the computing device 100. Therefore, the computing device 100 may enable the camera device 114 to capture image data to evaluate whether the data stream requires adjustment. In some cases, the adjustment may be based on a known color pattern as illustrated in FIG. 4. In any case, the calibration of the data stream may be provided to the external display device 402 such that colors being displayed at the external display device 402 are consistent with the colors displayed at the display device 110 of the computing device 100.

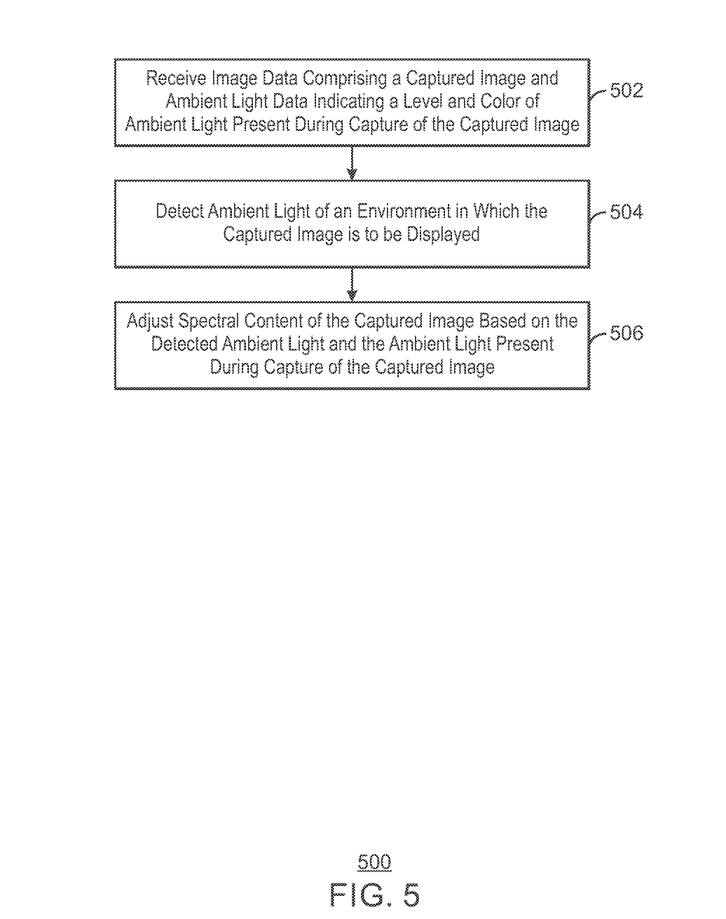

FIG. 5 is a block diagram illustrating a method of image rendering based on ambient light data. At block 502, image data is received including a captured image and ambient light data indicating a level of ambient light present during capture of the captured image. At block 504, ambient light of an environment in which the captured image is to be displayed is detected. At block 506, spectral content of the captured image is adjusted based on the detected ambient light and the ambient light present during capture of the image.

In embodiments, the method 500 further includes rendering the adjusted captured image at a display. In some cases, the method 500 may also include calibration of the display as discussed above in regard to FIG. 3.

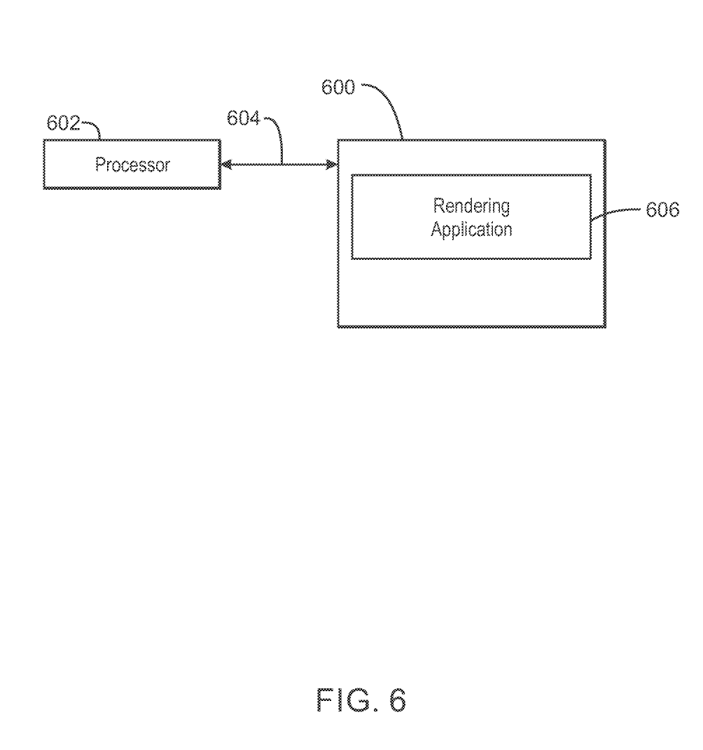

FIG. 6 is a block diagram depicting an example of a computer-readable medium configured to render images based on ambient light data. The computer-readable medium 600 may be accessed by a processor 602 over a computer bus 604. In some examples, the computer-readable medium 600 may be a non-transitory computer-readable medium. In some examples, the computer-readable medium may be a storage medium, but not including carrier waves, signals, and the like. Furthermore, the computer-readable medium 600 may include computer-executable instructions to direct the processor 602 to perform the steps of the current method.

The various software components discussed herein may be stored on the tangible, non-transitory, computer-readable medium 600, as indicated in FIG. 6. For example, a rendering application 606 may be configured to receive image data comprising a captured image and ambient light data indicating a level of ambient light present during capture of the captured image. The rendering application 606 may also be configured to detect ambient light of an environment in which the captured image is to be displayed, and adjust spectral content of the captured image based on the detected ambient light and the ambient light present during capture of the captured image.

Examples may include subject matter such as a method, means for performing acts of the method, at least one machine-readable medium including instructions that, when performed by a machine cause the machine to performs acts of the method.

Example 1 includes a system for image rendering. The system includes a processing device and modules to be implemented by the processing device. The modules include a data reception module to receive image data including an image and ambient light data indicating a level and color of ambient light present during capture of the captured image or equivalent white balance information. A detection module may be configured to detect ambient light of an environment in which the image is to be displayed. An adjustment module may be configured to adjust spectral content of the image based on the detected ambient light and the ambient light present during capture of the captured image or equivalent white balance information.

Example 2 includes a method for image rendering including receiving image data including a captured image and ambient light data indicating a level and color of ambient light present during image capture of the captured image. The method also includes detecting ambient light of an environment in which the captured image is to be displayed. The method also includes adjusting spectral content of the captured image based on the detected ambient light and the ambient light present during capture of the captured image. In some cases, a computer-readable medium may be employed to carry out the method of Example 2.

Example 3 includes a computer readable medium including code, when executed, to cause a processing device to receive image data comprising a captured image and ambient light or equivalent white balance data indicating a level and color of ambient light present during capture of the captured image, and detect ambient light of an environment in which the captured image is to be displayed. The computer readable medium may also include code, when executed, to cause the processing device to adjust spectral content of the captured image based on the detected ambient light and the ambient light present during capture of the captured image.

Example 4 includes an apparatus having a means to receive image data comprising a captured image and ambient light or equivalent white balance data indicating a level and color of ambient light present during capture of the captured image. The means is also configured to detect ambient light of an environment in which the captured image is to be displayed, and to adjust spectral content of the captured image based on the detected ambient light and the ambient light present during capture of the captured image.

Example 5 includes apparatus having logic, at least partially including hardware logic, to receive image data comprising a captured image and ambient light or equivalent white balance data indicating a level and color of ambient light present during capture of the captured image. The logic is also configured to detect ambient light of an environment in which the captured image is to be displayed, and to adjust spectral content of the captured image based on the detected ambient light and the ambient light present during capture of the captured image.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. A system for image rendering, comprising:
a processing device; and
modules to be implemented by the processing device, the modules comprising:
a data reception module to receive image data comprising an image and ambient light data indicating a level and color of ambient light present during capture of the captured image or equivalent white balance information;
a detection module to detect ambient light of an environment in which the image is to be displayed; and
an adjustment module to adjust spectral content of the image based on the detected ambient light and the ambient light present during capture of the captured image or equivalent white balance information.

2. The system of claim 1, further comprising a rendering module to render the adjusted captured image at a display.

3. The system of claim 1, further comprising a calibration application to calibrate the display, wherein the calibration application is to:
capture a first image of a first color pattern;
capture a second image of a reflection of a second color pattern being rendered at the display; and
apply correction coefficients to color channels to reduce a difference between the first image and the second image.

4. The system of claim 1, wherein the adjustment module is to dynamically adjust the spectral content as changes are detected in the ambient light of the environment in which the captured image is to be displayed.

5. The system of claim 1, wherein the captured image is a product of reflection of the ambient light upon a scene.

6. The system of claim 1, wherein the ambient light data is stored in an exchangeable image file format field.

7. The system of claim 1, wherein the detection module is further to:
identify a color of an object within the environment in which the captured image is to be displayed;
determine changes in the color of the object indicating changes in the ambient light.

8. The system of claim 1, further comprising an external display module to:
receive image data comprising a rendering of the captured image at an external display;
determine a color difference between the rendering of the captured image at the external display and a reference model of the captured image;
adjust a data feed to the external display based on the difference between the rendered image and the reference model.

9. The system of claim 8, further comprising a camera device, wherein the image data rendered at the external display is received via image capture at the camera device.

10. The system of claim 1, wherein the adjustment module is to correct a maladaptation resulting from a transmissive quality of a display of the system at which the captured image is to be displayed.

11. A method for image rendering, comprising:
receiving image data comprising a captured image and ambient light data indicating a level and color of ambient light present during capture of the captured image;
detecting ambient light of an environment in which the captured image is to be displayed; and
adjusting spectral content of the captured image based on the detected ambient light and the ambient light present during capture of the captured image.

12. The method of claim 11, further comprising rendering the adjusted captured image at a display.

13. The method of claim 11, further comprising calibrating a display, calibration comprising:
capturing a first image of a first color pattern;
capturing a second image of a reflection of a second color pattern being rendered at the display; and
applying correction coefficients to color channels to reduce a difference between the first image and the second image.

14. The method of claim 11, further comprising dynamically adjusting the spectral content as changes are detected in the ambient light of the environment in which the captured image is to be displayed.

15. The method of claim 11, wherein the captured image is a product of reflection of the ambient light upon a scene.

16. The method of claim 11, wherein the ambient light data is stored in an exchangeable image file format field.

17. The method of claim 11, further comprising:
identifying a color of an object within the environment in which the captured image is to be displayed; and
determining changes in the color of the object indicating changes in the ambient light.

18. The method of claim 11, further comprising:
receiving image data comprising a rendering of the captured image at an external display;
determining a color difference between the rendering of the captured image at the external display and a reference model of the captured image;
adjusting a data feed to the external display based on the difference between the rendered image and the reference model.

19. The method of claim 18, wherein the image data rendered at the external display is received via image capture at a camera device of a computing device communicatively coupled to the external display, further comprising providing the data stream to the external display.

20. The method of claim 11, wherein adjusting comprises correcting a maladaptation resulting from a transmissive quality of a display at which the captured image is to be displayed.

21. A computer readable medium including code, when executed, to cause a processing device to:
receive image data comprising a captured image and ambient light or equivalent white balance data indicating a level and color of ambient light present during capture of the captured image;
detect ambient light of an environment in which the captured image is to be displayed; and
adjust spectral content of the captured image based on the detected ambient light and the ambient light present during capture of the captured image.

22. The computer readable medium of claim 21, further comprising code, when executed, to cause the processing device to render the adjusted captured image at a display.

23. The computer readable medium of claim 21, further comprising code, when executed, to cause the processing device to:
capture a first image of a first color pattern;
capture a second image of a reflection of a second color pattern being rendered at the display; and
apply correction coefficients to color channels to reduce a difference between the first image and the second image.

24. The computer readable medium of claim 21, further comprising code, when executed, to cause the processing device to:
identify a color of an object within the environment in which the captured image is to be displayed; and
determine changes in the color of the object indicating changes in the ambient light.

25. The computer readable medium of claim 21, further comprising code, when executed, to cause the processing device to dynamically adjust the spectral content as changes are detected in the ambient light of the environment in which the captured image is to be displayed.
